(19) United States
(12) Patent Application Publication
(10) Pub. No.: US 2008/0004380 A1
(43) Pub. Date: Jan. 3, 2008

(54) Composition and method for preparing electron emitter, electron emitter prepared therefrom, and flat panel display comprising the same

(76) Inventors: Eun Kyung Bak, Anyang-si (KR); Okamoto Kuninori, Seongnam-si (KR); Yeong Seok Kim, Gunpo-si (KR)

Correspondence Address: LEE & MORSE, P.C., 3141 FAIRVIEW PARK DRIVE, SUITE 500, FALLS CHURCH, VA, 22042, US

(21) Appl. No.: 11/646,947

(22) Filed: Dec. 28, 2006

(30) Foreign Application Priority Data
Jun. 28, 2006 (KR) 10-2006-0058717

(51) Int. Cl. C08C 1/14

(52) U.S. Cl. 524/160

(57) ABSTRACT

Disclosed herein are a composition that can be used in the preparation of an electron emitter, a method of making the foregoing composition and an article made, at least in part, from the foregoing composition.

### CROSS-REFERENCE TO RELATED PATENT APPLICATION

This application claims priority under 35 U.S.C. §119(a)-(d) to Korean Patent Application No. 10-2006-0058717 filed on Jun. 28, 2006 which is herein incorporated by reference.

### BACKGROUND

1. Field

This application relates to a composition that can be used for preparing an electron emitter, a method for preparing an electron emitter using the composition, an electron emitter prepared by the method, and a flat panel display comprising the same.

2. Description of the Related Art

Field emission display (FED) is a type of flat panel display which can realize a desired picture by forming electric field by supply of voltage between anode and cathode electrodes to emit electrons from an electron emitter of the cathode electrode, and then causing the electrons to collide with the phosphor film on the anode electrode to emit light. An initially proposed FED is a spindt-type FED having a peaked front which is formed by laminating substances such as molybdenum(Mo) or silicon(Si) as electron emitters. However, the spindt-type FED having such an ultramicro structure is problematic that its preparation method is very complicated and requires high-accuracy preparation techniques. Further, due to the use of molybdenum or silicon having a high work function, a relatively high voltage should be applied to a gate electrode, thereby limiting to the production of large-area FEDs.

One alternative is to apply a nano-carbon material having a low work function to an electron emitter. Among such nano-carbon materials, carbon nanotube (CNT) can efficiently induce electron emission even under the application of a relatively low external voltage. These electron emitters can be used in flat panel display (FPD) and related technology.

The foregoing discussion in this section is solely to provide background information and does not constitute an admission of prior art.

### SUMMARY

One aspect provides a composition for preparing an electron emitter having superior storage stability. According to embodiments, the composition can comprise a nano-carbon material, a binder resin, a photosensitive vehicle, a photoinitiator, metal or metal oxide, a phosphate compound, and a solvent. Another aspect relates to a method of forming the foregoing composition. Another aspect relates to a method of preparing an electron emitter made from the foregoing composition and an electron emitter prepared by the method. Another aspect relates to a FPD made from the foregoing method.

### DETAILED DESCRIPTION OF EMBODIMENTS

As noted above, one aspect relates to a composition for preparing an electron emitter. According to embodiments, this composition can comprise a nano-carbon material, a binder resin, a photosensitive vehicle, a photoinitiator, metal or metal oxide, a phosphate compound and a solvent. The composition can optionally include additives such as viscosity improvement agents, resolution improvement agents, dispersing agents, forming agents and anti-oxidants.

Another aspect relates to a method of forming the foregoing composition. The composition can be used to form an electron emitter. According to embodiments, this method comprises the steps of providing the components of the composition and mixing the components to form the composition.

Another aspect relates to a method of preparing an electron emitter from the foregoing composition. According to embodiments, this method can comprise the steps of printing the foregoing composition on the surface of a cathode electrode formed on a substrate, drying the substrate, forming a certain pattern on the surface of the substrate and firing the substrate. Another aspect relates to an electron emitter prepared from the foregoing method. An additional aspect relates to a FPD prepared from the foregoing method. A more detailed description of the components of the composition and the various aspects of the invention follows.

### Nano-carbon Material

In various embodiments, the nano-carbon material can comprise carbon-based nano-particles. These particles can exhibit high conductivity and field emission property and functions to excite a fluorescent substance by emitting electrons upon the operation of an electron emission device. Examples of the nano-carbon material include, but are not limited to, carbon nanotubes (CNTs), carbon nanofibers, carbon nanocarbons and fullerenes. The method of producing the nano-carbon material is not particularly limited.

The nano-carbon material can comprise about 0.01%, 0.05%, 0.1%, 0.5%, 1%, 2%, 3%, 4%, 5%, 6%, 7%, 8%, 9%, 10%, 11%, 12%, 13%, 14% or 15% by weight with reference to the total weight of the composition. In addition, according to embodiments, the nano-carbon material can comprise a weight percentage of the composition in a range from about any of the foregoing amounts to about any other of the foregoing amounts.

### Binder Resin

The binder resin is not particuarly limited but can comprise an organic resin monomer or polymer that can react with the activated photosensitive vehicle to harden the composition. The organic resin monomer or polymer can comprise epoxy resins, acrylic resins or cellulose resins. According to embodiment, examples of epoxy resins include, but are not limited to, diglycidyl ether of bisphenol A (DGEBA), novolac resins, cycloaliphatic epoxy resins, brominated resins, and epoxidized olefins. According to embodiments, examples of acrylic resins include, but are not limited to, polymethyl acrylate. According to embodiments, examples of cellulose resins include, but are not limited to, ethyl cellulose and nitro cellulose.

In some embodiments, the binder resin can comprise about 1%, 5%, 10%, 20%, 30%, 40%, 50%, 60%, 65% or 70% by weight with reference to the total weight of the composition. In addition, according to embodiments, the binder resin can comprise a weight percentage of the composition in a range from about any of the foregoing amounts to any of the other foregoing amounts.

### Photosensitive Vehicle

The photoensitive vehicle can comprise a monomer or polymer comprising at least one unsaturated carbon-carbon bond and is capable of forming radicals after interaction with the photoinitiator. Once the photosensitive vehicle has formed radicals, the photosensitive vehicle can react with the binder resin to harden the composition.

Examples of the photosensitive monomer include, but are not limited to, acrylate monomers such as epoxy acrylate, polyester acrylate, methylacrylate, ethylacrylate, n-propylacrylate, isopropylacrylate, n-butylacrylate, sec-butylacrylate, iso-butylacrylate, tert-butylacrylate, n-pentylacrylate, allylacrylate, benzyacrylate, butoxyethylacrylate, butoxytriethyleneglycolacrylate, cyclohexylacrylate, dicyclopentylacrylate, dicyclopentenylacrylate, 2-ethylhexylacrylate, glycerolacrylate, glycidylacrylate, hetadecafluorodecylacrylate, 2-hydroxyethylacrylate, isobornylacrylate, 2-hydroxypropylacrylate, isodexylacrylate, isooctylacrylate, laurylacrylate, 2-methoxyethylacrylate, methoxyethyleneglycolacrylate, methoxydiethyleneglycolacrylate and mixtures.

The photosensitive polymer can be prepared by polymerizing at least one compound having a carbon-carbon unsaturated bond. The photosensitive polymer can have a weight average molecular weight of between about 400 and about 150,000. Examples of the photosensitive polymer include, but are not limited to, metacryl polymer, polyester acrylate, trimethylpropane triacrylate, trimethylolpropane triethoxy triacrylate, cresol epoxy acrylate oligomer and mixtures thereof.

In some embodiments, the photosensitive vehicle can comprise about 1, 5, 10, 20, 30, 40, 50, 60, 65 or 70% by weight with reference to the total weight of the composition. In addition, according to some embodiments, the photosensitive vehicle can comprise a weight percentage of the composition in a range from about any of the foregoing amount to about any of the other foregoing amounts.

### Photoinitiator

In various embodiments, the photoinitiator can comprise a compound comprising an aromatic ring that can form radicals upon exposure to certain wavelengths of light. Once activated, the photoinitiator interacts with the photosensitive vehicle to transform the photosesitive vehicle into radicals. Examples of the photoinitiator include, but are not limited to, benzophenone, o-benzoyl benzoic acid methyl, 4,4-bis(dimethylamine)benzophenone, 4,4-bis(diethylamino)benzophenone, 4,4-dichlorobenzophenone, 4-benzoyl-4-methyldiphenylketone, dibenzylketone, fluorenone, 2,2-diethoxyacetophenone, 2,2-dimethoxy-2-phenylacetophenone, 2-hydroxy-2-methylpropiophenone, p-t-butyldichloroacetophenone, thioxanthon, 2-methylthioxanthon, 2-chlorothioxanthon, 2-isopropylthioxanthon, diethylthioxanthon, benzyldimethylkethanol, benzylmethoxyethylacetal, benzoin, benzoinmethylether, benzoinbutylether, anthraquinone, 2-t-butyl anthraquinone, 2-amylanthraquinone, β-chloroanthraquinone, anthrone, benzanthrone, dibenzosuberone, methylenanthrone, 4-azidebenzalacetophenone, 2,6-bis(p-azidebenzylidene)cyclohexanone, 2,6-bis(p-azidebenzylidene)-4-methylcyclohexanone, 2-phenyl-1,2-butadion-2-(o-methoxycaronyl)oxim, 2,3-bis(4-diethylaminobenzal)cyclopentanon, 2,6-bis(4-dimethylaminibenzal)cyclohexanone, 2,6-bis(4-dimethylaminobenzal)-4-methylcyclohexanone, Michler's ketone, 4,4-bis(diethylamino)-benzophenone, 4,4-bis(dimethylamino)chalcone, 4,4-bis(diethylamino)chalcone, p-dimethylaminocinnamylideneindanone, p-dimethylaminobenzylidindanone, 2-(p-dimethylaminophenylvinylene)-isonaphthotiazolo, 1,3-bis(4-dimethylaminozal)acetone, 1,3-carbonyl-bis(4-diethylaminobenzal)acetone, 3,3-carbonyl-bis(7-diethylaminocoumalin), N-phenyl-N-ethylethanolamine, N-phenylethanolamine, N-tolyldiethanolamine, N-phenylethanolamine, dimethylaminobenzoic acid isoamyl, diethylaminobenzoic acid isoamyl, 3-phenyl-5-benzoylthio-tetrazole, 1-phenyl-5-ethoxycarbonylthio-tetrazole and mixture thereof.

The photoinitiator can comprise about 0.01%, 0.05%, 0.1%, 0.5%, 1%, 3%, 5%, 8%, 10%, 12%, or 15% by weight with reference to the total weight of the photosensitive vehicle. Further, according to embodiments, the photoinitiator can comprise a weight percentage of the photosensitive vehicle in a range from about any of the foregoing amounts to any of the other foregoing amounts.

### Metal or Metal Oxide

The metal or metal oxide is not particularly limited but functions to improve the conductivity of the composition for preparing an electron emitter. Examples of the metal or metal oxide include, but are not limited to, Ag, Ni, Ti, Si, Sn, B, Ta, Zr, Sr, Al, In, and TiO2, SiO2, SnO, B2O3, ZrO, SrZrO3, Al2O3, In2O3 and mixtures thereof.

The metal or metal oxide can comprise about 5%, 10%, 20%, 30%, 40%, 50% or 60% by weight with reference to the total weight of the composition. Further, according to embodiments, the metal or metal oxide can comprise a weight percentage of the composition in a range from about any of the foregoing amounts to any of the other foregoing amounts.

### Phosphate Compound

The phosphate compound is not particularly limited and can comprise a monomer or polymer comprising a phosphate (H₂PO₄) group. In some embodiments, the phosphate compound can comprise a mixture of monomers and/or polymers comprising a phosphate group. According to embodiments, the phosphate compound can further comprise an ether group or an ester group. In some embodiments, the acid value of the phosphate compound can comprise about 50, 100, 200, 300, 400, 500 or 600 mgKOH/g. In addition, according to embodiments, the acid value of the phosphate compound can comprise an amount in a range from about any of the foregoing amounts to about any of the other foregoing amounts. According to embodiments, the molecular weight of the phosphate compound can range from about 300 to about 7,000. One example of the phosphate compound is the phosphate compound marketed under the tradename DISPERBYK-111 by BYK Inc. Note that this example is merely for illustrative purposes and does not limit the invention in any manner.

In some embodiments, the phosphate compound can comprise about 0.01, 0.05, 1, 3, 5, 8, 10, 13 or 15% by weight with referenc to the total weight of the composition. In addition, according to embodiments, the phosphate compound can comprise a weight percentage of the composition in a range from about any of the foregoing amounts to any of the other foregoing amounts.

### Solvent

The solvent is not particularly limited and includes, but is not limited to, comprise ethyl cellosolve, ethyl carbitol, ethyl carbitol acetate, butyl cellosolve, butyl carbitol, butyl carbitol acetate, terpineol, texanol, and mixtures thereof.

### Optional Additives

In some embodiments, the composition can optionally include additives such as viscosity improvement agents, resolution improvement agents, dispersing agents, foaming agents, anti-oxidants, and the like.

### Preparing the Composition

As described above, another aspect relates to a method of preparing the foregoing composition. This method includes providing a nano-carbon material; providing a binder resin; providing a photosensitive vehicle; providing a photoinitiator, providing a metal or metal oxide; providing a phosphate compound; providing a solvent; and mixing the nano-carbon material, the binder resin, the photosensitive vehible, the photoinitiator, the metal or metal oxide, the phosphate compound and the solvent. The method can further include other steps such as providing other additives such as viscosity improvement agents, resolution improvement agents dispersing agents, foaming agents and anti-oxidants.

According to embodiments, the foregoing components are mixed together all at once. Alternatively, one or more of the components can be added individually. Further, the order of mixing the foregoing components is not particularly limited.

### Preparation of an Electron Emitter from the Composition

As described above, another aspect relates to a method of making an electron emitter from the foregoing composition. According to embodiments, this method includes the steps of printing the foregoing composition on the surface of a cathode electrode formed on a substrate; drying the substrate; forming a certain pattern through ultraviolet irradiation and alkali development; and firing the substrate to remove an organic binder layer.

According to embodiments, the step of printing the composition on the surface of a cathode electrode formed on a substrate can comprise typical methods of printing. Examples of printing methods include, but are not limited to, screen printing, spray coating, spin coating, roll coating and dipping.

In some embodiments, the step of drying the substrate functions to remove solvents.

In some embodiments, the step of forming a certain pattern through ultraviolet irradiation and alkali development comprises the steps of irradiating certain portions of the printed composition with certain wavelengths of light and developing the substrate with an alkali solution. Irradiating certain portions of the printed composition causes the photoinitiator of the composition located at or near those portions to form radicals which interact with the photosensitive vehicle at or near those portions to form radicals which, in turn, interact with the binder resin. These interactions results in cross-polymerization or copolymerization reactions between the binder resin and the photosensitive vehicle. As a result, the composition at or near that irradiated portion can cure and harden. According to embodiments, the photoinitiator does not participate in the reaction if it is not modified by the light. According to embodiments, during the development process by the alkali aqueous solution, the non-reacted binder resin, non-reacted photosensitive vehicle, photoinitiator and the CNT in the area of the non-copolymerized binder resin-photosensitive vehicle portions can be disintegrated or washed away. In some embodiments, the development process by the alkali aqueous solution does not remove substantial portions of the reacted, hardened or copolymerized binder resin-photosensitive vehicle portions and CNT located therein or nearby.

The firing step can comprise subjected the subject and composition to a temperature in the range from about 200° C. to about 700° C. Here, the firing temperature may be determined within an appropriate range by considering the relationship between complete combustion temperature of the organic binder resin and oxidation temperature of the nano-carbon material. According to embodiments, the firing step can cause a portion of the remaining reacted or copolymerized binder resin-photosensitive vehicle portions or material to become ash and/or disintegrate. However, according to embodiments, the firing step can cause the remaining CNT and a portion of the reacted binder resin and photosensitive vehicle to remain in a specified pattern based on the pattern of light irradiation. Thus, after the firing step, an array of CNT on a cathode electrode on a substrate can be formed in order to form an electron emitter.

### An Electron Emitter Made from the Method

Another aspect relates to an electron emitter prepared according to the method of forming an electron emitter described above. The electron emitter prepared according to the present invention can be effectively used as a cathode of a FPD, and more particularly, a cathode of an electron emission device.

The present descriptions may be better understood with reference to the following examples which are intended for the purpose of illustration and are not to be construed as in any way limiting the scope of the present invention.

### EXAMPLES

### Example 1

Carbon nanotubes (SWNT, CNI Inc.) 3.3 g and a metacrylic acid methylmetacrylate copolymer (MMA-MAA, molecular weight 30,000) 22 g, titanium dioxide powders 33 g, terpineol (KISHIDA Inc.) 33 g, epoxy acrylate 11 g and a photointiator (HSP-188, SK-UCB Inc.) 2.2 g were added to a 120 Ml PP (polypropylene) sample container, a phosphate compound (Disperbyk-111, BYK Inc., acid value: 129 mgKOH/g) 5.5 g was added thereto, and then, all the ingredients were mixed with a 3-roll miler and completely dispersed, to obtain a paste composition A.

### Example 2

Composition B was prepared according to the same method as described in Example 1 except that titanium dioxide powders 33 g, terpineol 30 g and a phosphate compound 8.5 g were employed.

### Comparative Example 1

Composition C was prepared according to the same method as described in Example 1 except that terpineol 38.5 g was employed without using a phosphate compound.

### Comparative Example 2

Composition D was prepared according to the same method as described in Example 1 except that terpineol 22 g and a phosphate compound 16.5 g were employed.

Compositions A through D prepared above were subjected to the measurement and assessment of storage stability and current density as follows, and the results are shown in Table 1.

TABLE 1

| | | | Current |
|---|---|---|---|
| | Paste composition | Storage stability | density (μA/cm²) |
| Example 1 | A | ∘ | 330 |
| Example 2 | B | x | 320 |
| Comparative | C | x | 360 |
| Example 1 | | | |
| Comparative | D | ∘ | 120 |
| Example 2 | | | |

### Property Assessment Method

### Storage Stability

Each of compositions A through D was filled in a 50 cc glass vial, allowed to stand at room temperature for 3 days, and then, it was observed whether or not phase separation is occured in the top of the paste composition. At this time, the case where the phase separation is occurred was marked “x”, and the case where no phase separation is occurred was marked “o”.

### Amount of Emitted Electron

Each of compositions A through D was printed on the surface of a glass substrate coated with ITO in a pattern of 2 cm×2 cm. The substrate was dried at 65° C. for 10 minutes, irradiated with 1 J UV, developed with an alkali solution, and then, fired at 400° C., to obtain a test sample. After the test sample so prepared was placed within a vacuum chamber, the amount of electron emitted from the test sample was measured by using a pulse power source and an ammeter, wherein a current density per unit area was calculated therefrom.

As can be seen from Table 1, composition A showed excellent long-term storage stability, and an electron emitter prepared by using the composition shows a stable and uniform electron emission property of nano-carbon materials.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition comprising:
a nano-carbon material;
a binder resin;
a photosensitive vehicle;
a photoinitiator;
metal or metal oxide; and
a phosphate compound.

2. The composition according to claim 1, wherein the nano-carbon material comprises from about 0.01% to about 15% by weight with reference to the total weight of the composition, the binder resin comprises from about 1% to about 70% by weight with reference to the total weight of the composition, the photosensitive vehicle comprises from about 1% to about 70% by weight with reference to the total weight of the composition, the photoinitiator comprises from about 0.01% to about 15% by weight with reference to the total weight of the photosenstive vehicle, the metal or metal oxide comprises from about 5% to about 60% by weight with reference to the total weight of the composition and the phosphate compound comprises from about 0.01% to about 15% by weight with reference to the total weight of the composition.

3. The composition according to claim 1, wherein the nan-carbon material is selected from the group consisting of carbon nanotubes, carbon nanofibers, carbon nanohorns and mixtures thereof.

4. The composition according to claim 1, wherein the photosensitive vehicle comprises a compound selected from the group consisting of a photosesitive acrylate, a photosensitive acrylate-derived monomer, a photosensitive polymer comprising a weight average molecular weight from about 300 to about 150,000 and mixtures thereof.

5. The composition according to claim 1, wherein the binder resin comprises a compound selected from the group consisting of an acrylic resin, an epoxy resin, a cellulosic resin and combinations thereof.

6. The composition according to claim 1, wherein the photoinitiator comprises a compound comprising an aromatic ring moiety.

7. The composition according to claim 1, wherein the phosphate compound comprises a molecular weight from about 300 to about 7,000.

8. The composition according to claim 1, wherein the phosphate compound comprises an acid value from about 50 to about 800 mgKOH/g.

9. The composition according to claim 1, wherein the phosphate compound comprises a copolymer comprising a phosphate group, an ether group and an ester group.

10. A method of making a composition, the method comprising:
providing a nano-carbon material;
providing a binder resin;
providing a photoinitiator;
providing a metal or a metal oxide;
providing a phosphate compound; and
mixing the nano-carbon material, the binder resin, the photoinitiator, the metal or metal oxide and the phosphate compound to form a mass.

11. The method of claim 10, wherein the nano-carbon material comprises from about 0.01% to about 15% by weight with reference to the total weight of the composition, the binder resin comprises from about 1% to about 70% by weight with reference to the total weight of the composition, the photosensitive vehicle comprises from about 1% to about 70% by weight with reference to the total weight of the composition, the photoinitiator comprises from about 0.01% to about 15% by weight with reference to total weight of the photosesitive vehicle, the metal or metal oxide comprises from about 5% to about 60% by weight with reference to the total weight of the composition and the phosphate compound comprises from about 0.01% to about 15% by weight with reference to the total weight of the composition.

12. The method of claim 10, wherein the phosphate compound comprises a molecular weight from about 300 to about 7,000 and an acid value from about 50 to about 800 mgKOH/g.

13. The method of claim 10, wherein the phosphate compound comprises from about 5% to about 10% by weight with reference to the total weight of the composition.

14. The method of claim 10, further comprising the steps of:
printing the composition on the surface of an electrode formed on a substrate;
drying the substrate;
irradiating the composition with ultraviolet light;
developing the substrate with an alkali solution; and
firing the substrate at a temperature from about 200° C. to about 600° C.

15. An electron emitter prepared according to the method of claim 14.

16. An electron emitter according to claim 15, wherein the electron emitter comprises a flat panel display.
